(19) United States
(12) Patent Application Publication
(10) Pub. No.: US 2006/0021934 A1
(43) Pub. Date: Feb. 2, 2006

(54) Method and system for fabricating filter structure

(76) Inventors: Chang-Min Cho, Gyeonggi-do (KR); Jung-Sung Hwang, Gyeonggi-do (KR); Dong-Seok Ham, Gyeonggi-do (KR); Ha-Na Kim, Seoul (KR)

Correspondence Address: MARGER JOHNSON & MCCOLLOM, P.C., 210 SW MORRISON STREET, SUITE 400, PORTLAND, OR, 97204, US

(21) Appl. No.: 11/089,456

(22) Filed: Mar. 22, 2005

(30) Foreign Application Priority Data
Aug. 2, 2004 (KR) 2004-60812

(51) Int. Cl. B01D 29/07

(52) U.S. Cl. 210/499; 210/505; 156/60; 156/64

(57) ABSTRACT

The invention discloses a method and system for fabricating a filter structure. The method for fabricating the filter structure comprises preparing a filtering net having mesh patterns, injecting an adhesive on the filtering net, and adhering refining materials to the filtering net coated with the adhesive. Here, the adhesive is injected to have a smaller size than an interval of the mesh patterns. The system for fabricating the filter structure comprises a filtering net, a filtering net transfer device for transferring the filtering net, and an adhesive injection device for injecting an adhesive solution on the filtering net.

### CROSS-REFERENCE TO RELATED APPLICATIONS

This U.S. non-provisional patent application claims priority and benefit of Korean Patent Application 2004-60812 filed on 2 Aug. 2004, the entire contents of which are hereby incorporated by reference.

### BACKGROUND OF THE INVENTION

The disclosure relates to a system for fabricating a filter structure of an air filter and a method for fabricating the filter structure by using the system.

With the advances in industrial technologies, there are increasing demands for cleanrooms, which are contaminant-free spaces. Especially, productivity in precision technology fields such as semiconductors, optical instruments, space-air, electronics, chemicals, foods and hospitals is very much influenced by the amount of contaminants. Therefore, demands for cleanrooms have enormously increased in the precision technology field.

A cleanroom is a contaminant-free space in which the amount of contaminants, such as dusts and chemical materials, is smaller than a reference value. The technical standard for cleanrooms has been prescribed in the US Federal Standard 209. In order to control contamination, a cleanroom includes a dust filter for removing dusts from the air and a chemical filter for removing chemical materials. Each of the dust filter and the chemical filter consists of a filtering net having mesh patterns and a casing for supplying a path of air flow passing through the filtering net. Refining materials may be adhered to the filtering net. Here, the types of refining materials are dependent upon the types of contaminants to be removed.

FIGS. 1A and 1B are exemplary diagrams illustrating a conventional method for fabricating a filter structure that adheres active carbons to a filtering net. Referring to FIGS. 1A and 1B, in order to adhere the active carbons 30 to the filtering net 10, an adhesive 20 is painted on the filtering net 10 according to a brushing process.

However, the brushing process cannot evenly coat the adhesive 20 on the filtering net 10. If the brushing process is manually performed (as in the general methods), the adhesive 20 is seriously unevenly coated on the filtering net 10. As a result, as shown in FIG. 1A, the adhesive 20 partially or wholly fills the mesh patterns of the filtering net 10 in predetermined regions 25, which causes a mesh closing phenomenon. The mesh closing phenomenon increases an area of the adhesive 20 in the filtering net 10 and decreases a sectional area for air flow passing through the filtering net 10. A decrease in the sectional area for the air flow causes pressure loss and reduces the longevity of the filter. In addition, the mesh closing phenomenon increases the amount of the active carbons 30 adhered to the filtering net 10 and, thus, increases the weight of the filter.

### SUMMARY OF THE INVENTION

The invention is directed to a method for fabricating a filter structure having uniform coatings of adhesive and refining materials. The invention is also directed to a system for fabricating a filter structure having uniform coatings of adhesive and refining materials.

In one embodiment, the invention provides a method for fabricating a filter structure including a step for injecting an adhesive. The method for fabricating the filter structure comprises preparing a filtering net having mesh patterns, injecting an adhesive on the filtering net to produce an even coating, and adhering refining materials to the filtering net coated with the adhesive.

According to one embodiment of the invention, the step for injecting the adhesive comprises supplying the adhesive to an injection device having injection nozzles, and injecting the supplied adhesive by applying a pressure to the injection device. Preferably, the adhesive is maintained at a first temperature in the injection device.

According to another embodiment of the invention, the method for fabricating the filter structure further comprises a temperature control step for changing the temperature of the adhesive coated on the filtering net into a second temperature before adhering the refining materials. Preferably, the second temperature is lower than the first temperature.

Preferably, the adhesive is injected to have a smaller size than an interval of the mesh patterns of the filtering net. Preferably, the adhesive is selected from the group consisting of urethane group adhesive, polyurethane group adhesive, aqueous vinylurethane group adhesive, epoxy group adhesive, acryl group adhesive, silicon group adhesive and synthetic resin group adhesive. Preferably, the refining materials are selected from the group consisting of active carbons, impregnated active carbons, inorganic adsorbents and resins.

Another embodiment of the invention provides a system for fabricating a filter structure, comprising: a filtering net disposed to cross a first position and a second position; a filtering net transfer device connected to the filtering net in the second position, for transferring the filtering net from the first position to the second position; and an adhesive injection device disposed between the first position and the second position, for injecting an adhesive solution on the filtering net.

Preferably, the filtering net is made of materials selected from the group consisting of metallic materials comprising aluminum, and polymers comprising polyethylene (PE), polypropylene (PP), polystyrene (PS), polyvinyl chloride (PVC), ethylene vinylacetate (EVA), polyethylene terephthalate (PET), polycarbonate (PC), polybutylene terephthalate (PBT), polyacetal (PA) and polyamide (PC). Preferably, the filtering net has mesh patterns formed at predetermined intervals.

Preferably, the adhesive solution is one selected from the group consisting of urethane group adhesive, polyurethane group adhesive, aqueous vinylurethane group adhesive, epoxy group adhesive, acryl group adhesive, silicon group adhesive and synthetic resin group adhesive.

In accordance with the invention, the adhesive injection device transforms the adhesive solution into adhesive solution drops having a smaller size than the interval of the mesh patterns of the filtering net and transfers the adhesive solution drops toward the filtering net. The adhesive injection device comprises an adhesive solution supply line having one end connected to an adhesive solution material vessel, an adhesive solution storing unit connected to the other end of the adhesive solution supply line, and one or more injection nozzles connected to the adhesive solution storing unit. Preferably, the injection nozzles are divergent nozzles for transforming the adhesive solution into minute liquid drops.

According to one embodiment of the invention, the adhesive injection device further comprises a first control device for controlling the adhesive solution at a first temperature. Preferably, the first control device is disposed at the peripheral regions of the adhesive solution supply line and the adhesive solution storing unit. Here, the first control device is a heat transfer device.

According to another embodiment of the invention, a refining material supply device is further disposed between the adhesive injection device and the filtering net transfer device. The refining material supply device supplies at least one refining material selected from the group consisting of active carbons, impregnated active carbons, inorganic adsorbents and resins.

According to yet another embodiment of the invention, a second control device for controlling the injected adhesive at a second temperature is disposed between the refining material supply device and the adhesive injection device. Preferably, the second control device is a cooling device.

### BRIEF DESCRIPTION OF THE DRAWINGS

The foregoing and other features and advantages of the embodiments of the invention will become readily apparent by reference to the following detailed description when considered with the accompanying drawings.

FIGS. 1A and 1B are exemplary diagrams illustrating a conventional method for fabricating a filter structure.

FIGS. 2A to 2C are flowcharts showing the methods for fabricating filter structures in accordance with embodiments of the invention.

FIGS. 3A and 3B are exemplary diagrams illustrating a process for fabricating a filter structure in accordance with embodiments of the invention.

FIGS. 4A to 4D are schematic diagrams illustrating systems for fabricating filter structures in accordance with embodiments of the invention.

FIGS. 5A to 5D are schematic cross-sectional diagrams illustrating adhesive injection devices in accordance with the embodiments of the invention.

FIGS. 6 and 7 are graphs showing technical effects of the invention.

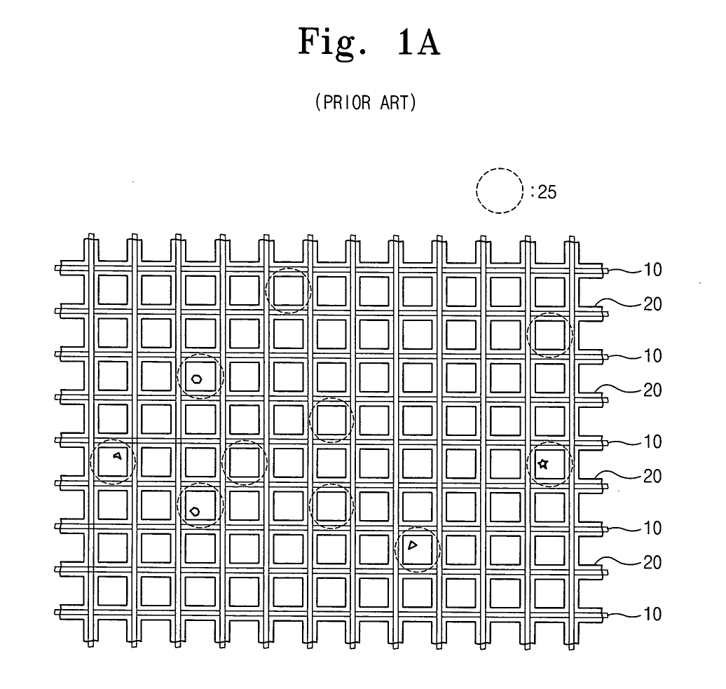

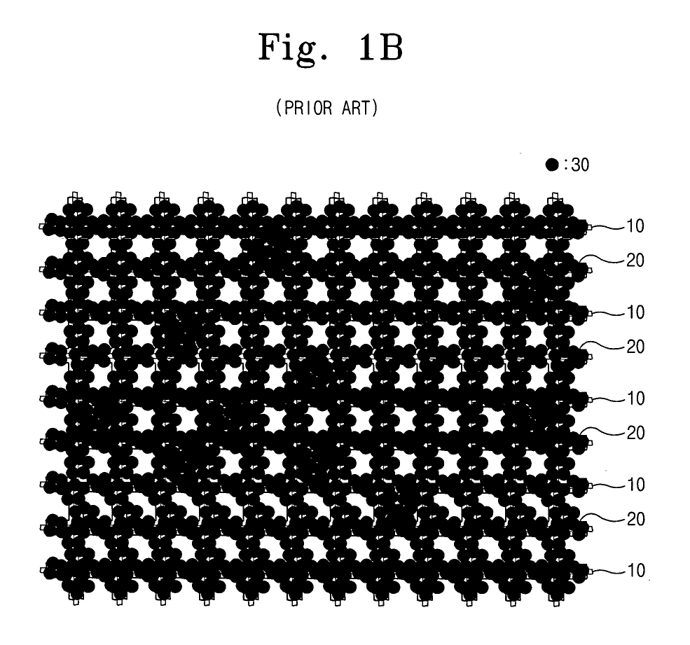

### DETAILED DESCRIPTION OF THE EMBODIMENTS

The invention will be described below with reference to the accompanying drawings, in which embodiments of the invention are shown. However, this invention may be embodied in many different forms and should not be constructed as limited to the embodiments set forth herein. Rather, these embodiments are provided so that this disclosure will be thorough and complete, and will fully convey the scope of the invention to those skilled in the art. In the drawings, the thicknesses of layers and regions are exaggerated for clarity. It will be understood that when an element such as a layer, a region, or a substrate is referred to as being “on” another element, it can be directly on the other element or intervening elements may also be present.

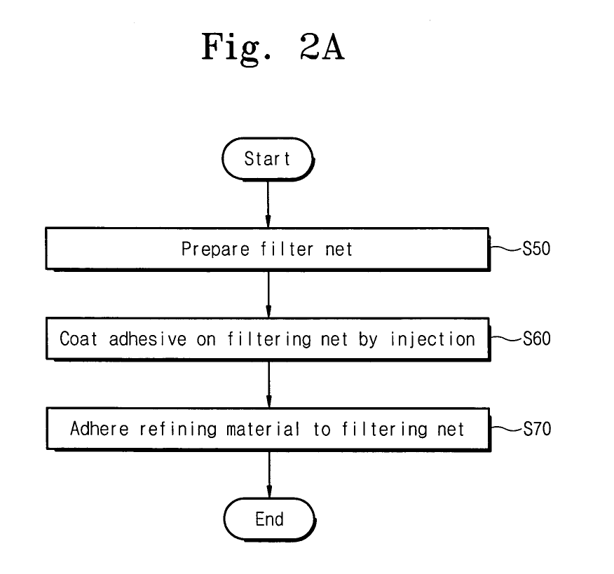

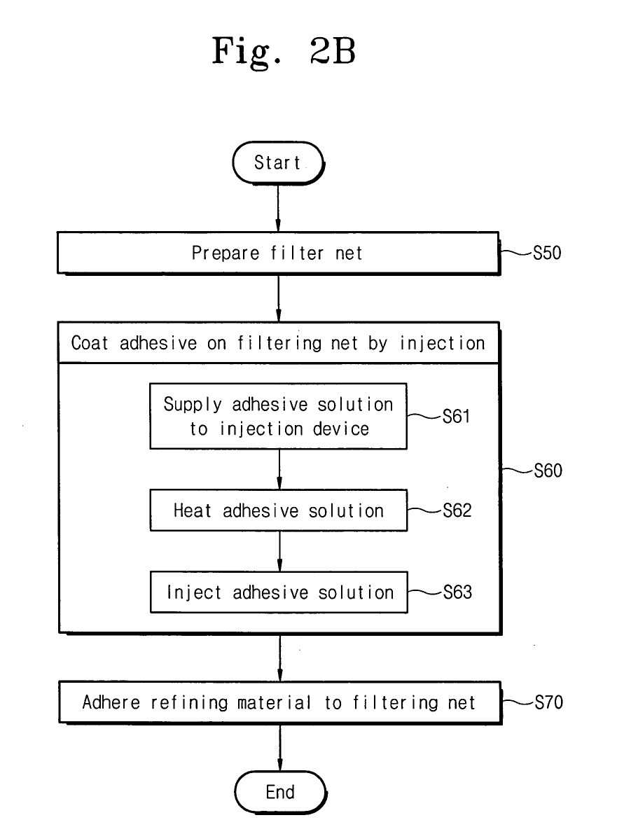

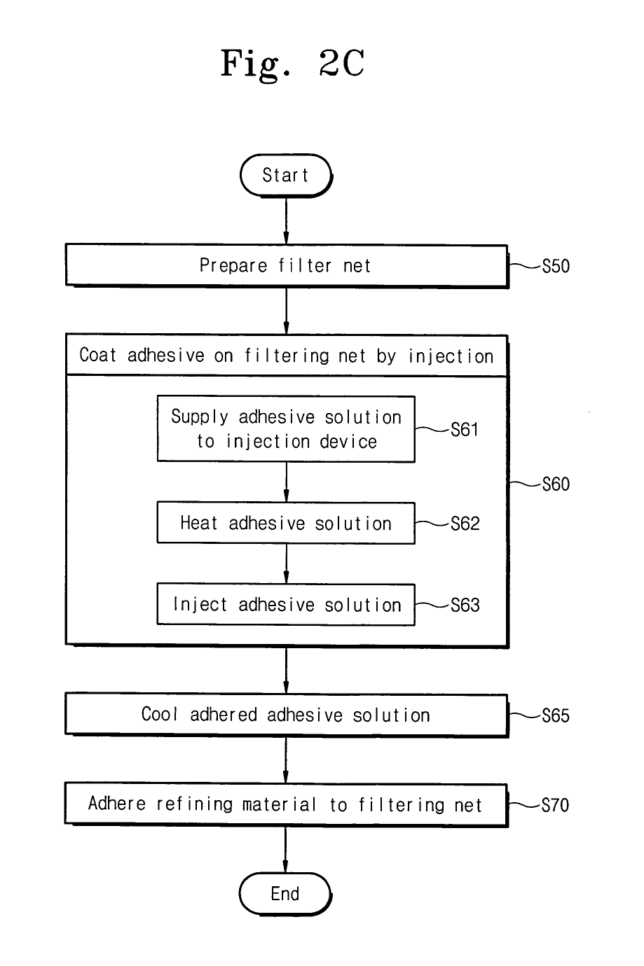

FIGS. 2A to 2C are flowcharts showing the methods for fabricating filter structures in accordance with embodiments of the invention.

As illustrated in FIG. 2A, a filtering net having a predetermined size of mesh patterns is prepared (step S50). Preferably, the filtering net is made of aluminum, but may be made of materials selected from the group consisting of polymers comprising polyethylene (PE), polypropylene (PP), polystyrene (PS), polyvinyl chloride (PVC), ethylene vinylacetate (EVA), polyethylene terephthalate (PET), polycarbonate (PC), polybutylene terephthalate (PBT), polyacetal (PA) and polyamide (PC), and other metallic materials.

After preparing the filtering net, an adhesive is coated on the filtering net (step S60). The coating step comprises injecting to the filtering net adhesive solution drops having a smaller size than an interval of the mesh patterns of the filtering net. Since a small size of adhesive solution drops are injected to the filtering net, the adhesive may be evenly coated on the filtering net. Preferably, the adhesive is urethane group adhesive, but may be selected from the group consisting of polyurethane group adhesive, aqueous vinylurethane group adhesive, epoxy group adhesive, acryl group adhesive, silicon group adhesive and synthetic resin group adhesive.

After coating the filtering net with adhesive, refining materials are adhered to the filtering net coated with the adhesive (step S70). Preferably, the refining materials are impregnated active carbons, but may be selected from the group consisting of active carbons, inorganic adsorbents and resins. Here, the types of refining materials are dependent upon the types of contaminants to be removed. When contacting the adhesive, the refining materials are fixed in the contact positions. Therefore, the refining materials may be adhered to the filtering net in various ways. For example, in a process of spreading the refining materials on the filtering net coated with the adhesive and clearing the refining materials from the filtering net, the refining materials may be adhered to the filtering net.

On the other hand, in the injection step (step S60), the size of the adhesive solution drops is selected based on the viscosity of the adhesive solution, the structure of injection nozzles, and the pressure applied to the adhesive solution. Viscosity of the adhesive solution is a temperature-dependent physical property. Accordingly, a process for controlling the adhesive solution at a predetermined temperature may be additionally performed to control the size of the adhesive solution drops. For example, as shown in FIG. 2B, the step of coating the adhesive (step S60) comprises supplying the adhesive solution to an injection device having injection nozzles (step S61), heating the supplied adhesive solution at a first temperature (step S62), and injecting the heated adhesive solution through the injection nozzles (step S63).

Here, the adhesive solution is heated (step S62), so as not to be cooled and hardened in the injection device. Thus, the injection device may avoid errors by the hardened adhesive solution. Preferably, the first temperature is controlled below 40° C.

In another embodiment of the invention, a step for controlling the heated and coated adhesive solution at a second temperature (step S65) may be additionally performed (refer to FIG. 2C). In general, viscosity of the adhesive solution is inversely proportional to temperature. Therefore, the heated adhesive solution may not have sufficient viscosity to adhere the refining materials. If necessary, as shown in FIG. 2C, a step for cooling the adhesive solution coated on the filtering net may be further performed before adhering the refining materials (step S70).

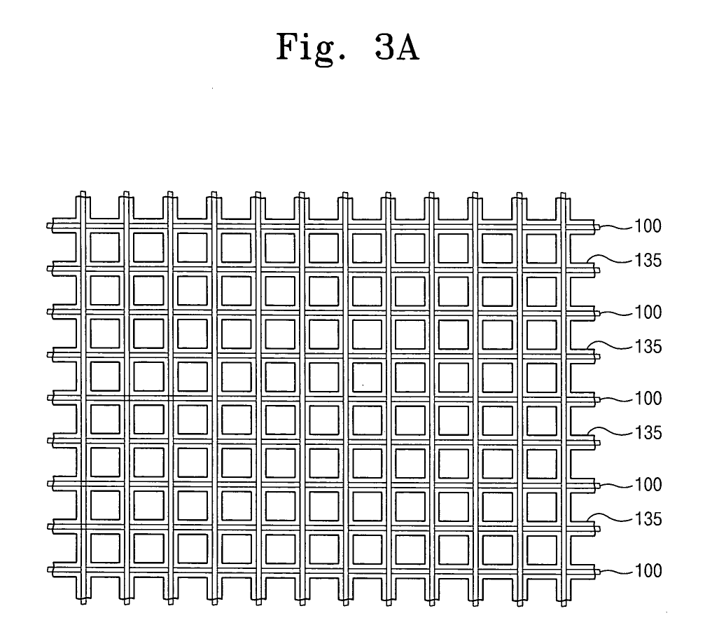

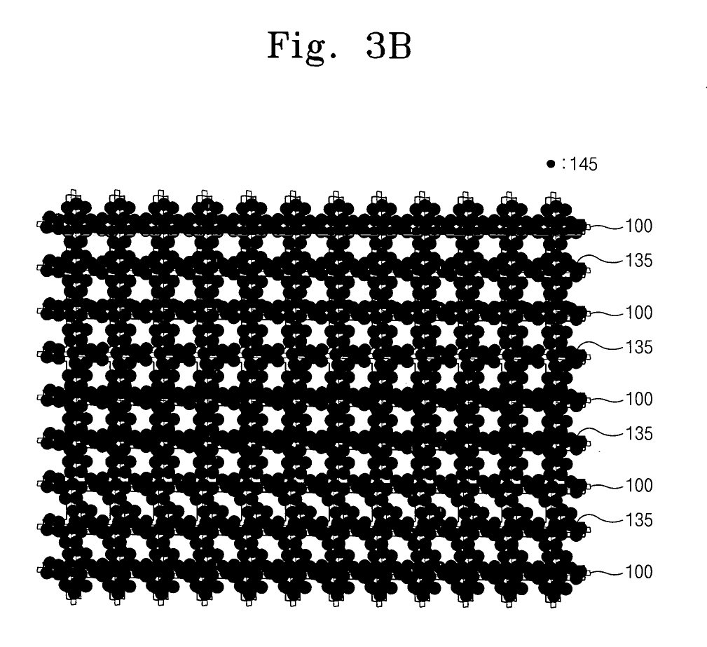

In accordance with the invention, as depicted in FIG. 3A, the adhesive solution 135 is injected on the filtering net 100 to evenly coat the filtering net 100. As illustrated in FIG. 3B, the refining materials 145 (for example, impregnated active carbons) are also evenly adhered to the filtering net 100.

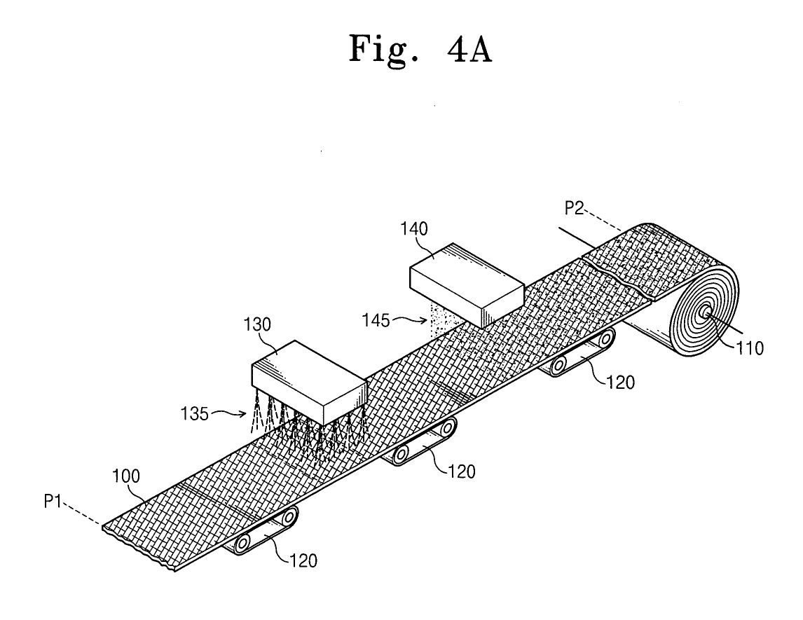

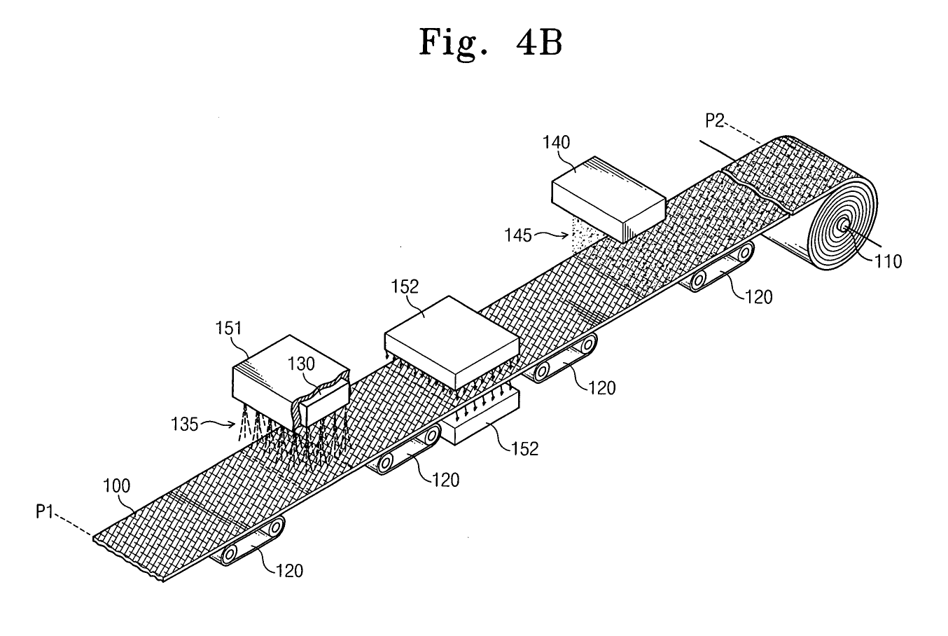

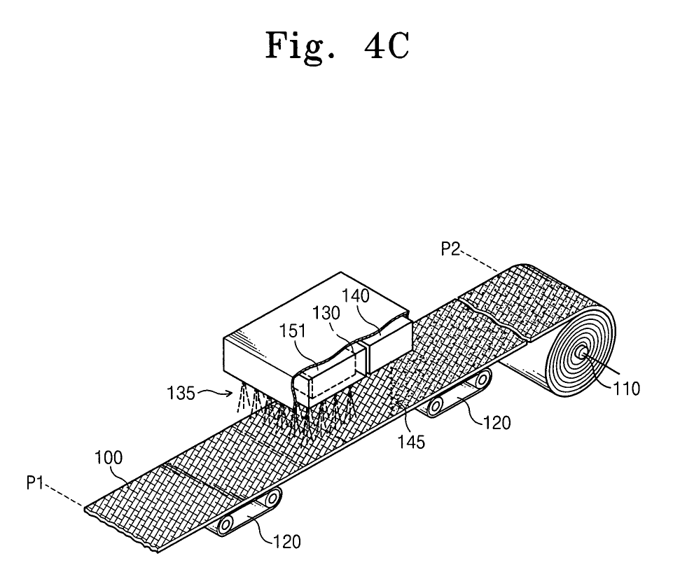

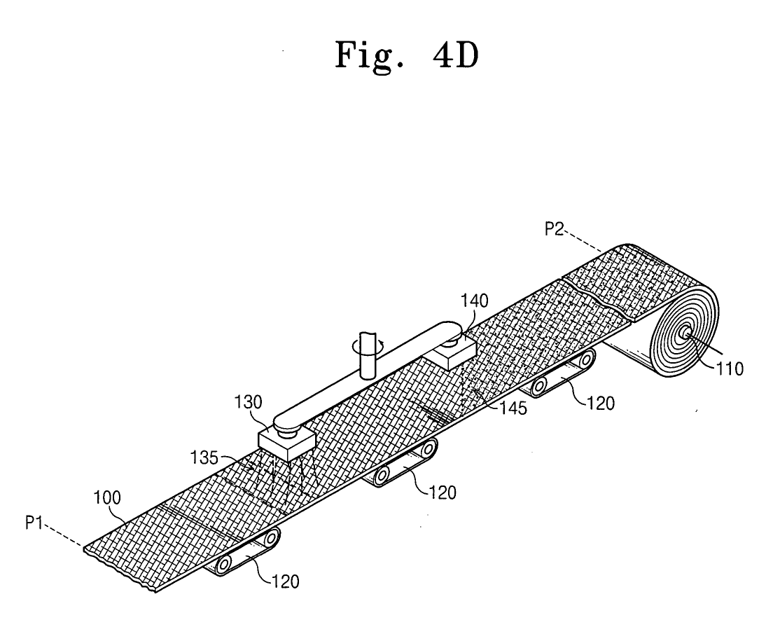

FIGS. 4A to 4D are schematic diagrams illustrating systems for fabricating filter structures in accordance with embodiments of the invention.

Referring to FIG. 4A, a filtering net 100 having a predetermined size of mesh patterns is disposed to cross a first position P1 and a second position P2 separated from each other. Preferably, the filtering net 100 is made of aluminum, but may be made of materials selected from the group consisting of polymers comprising polyethylene (PE), polypropylene (PP), polystyrene (PS), polyvinyl chloride (PVC), ethylene vinylacetate (EVA), polyethylene terephthalate (PET), polycarbonate (PC), polybutylene terephthalate (PBT), polyacetal (PA) and polyamide (PC), and other metallic materials.

A filtering net transfer device 110 connected to one end of the filtering net 100 is disposed in the second position P2. When it is presumed that a part of the filtering net 100 disposed in the first position P1 at an initial stage is a first part, the filtering net transfer device 110 transfers the filtering net 100 after a predetermined time (δt>0) so that the first part can be close to the second position P2. Preferably, the filtering net transfer device 110 is a roller for rolling the filtering net 100 on a fixed axis. In order to prevent the filtering net 100 from being loosened in the down direction, support units 120 may be installed under the filtering net 100.

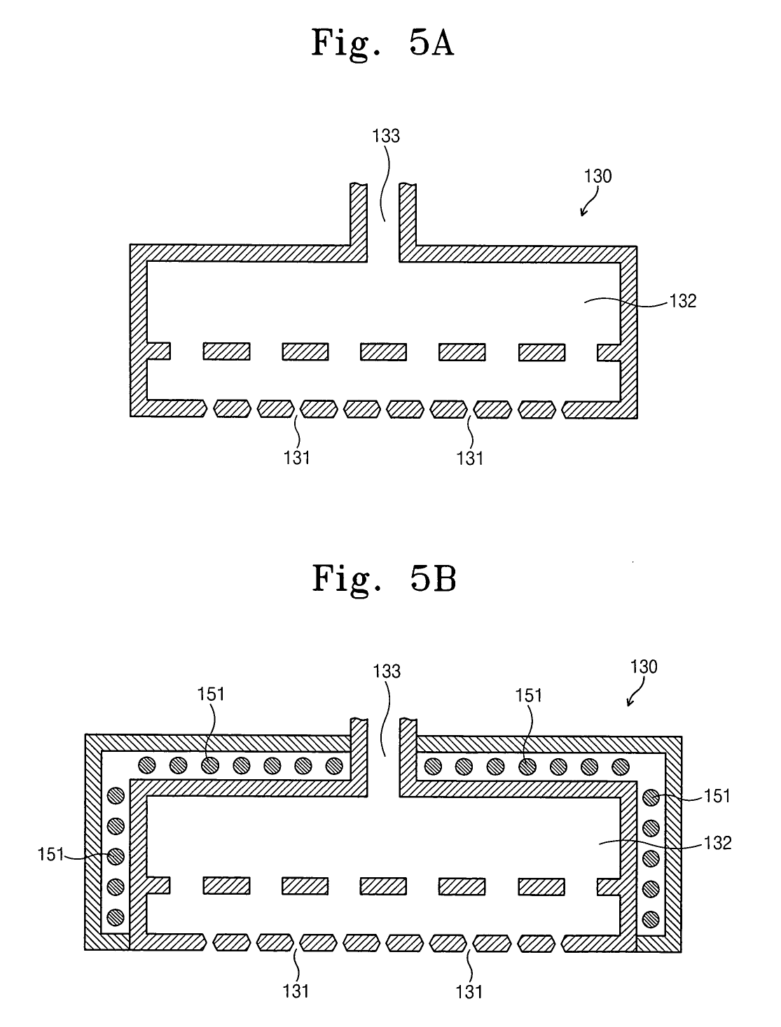

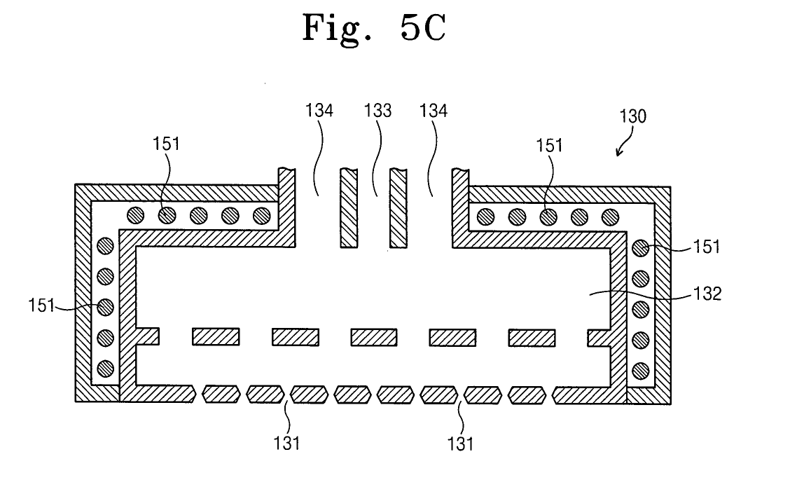

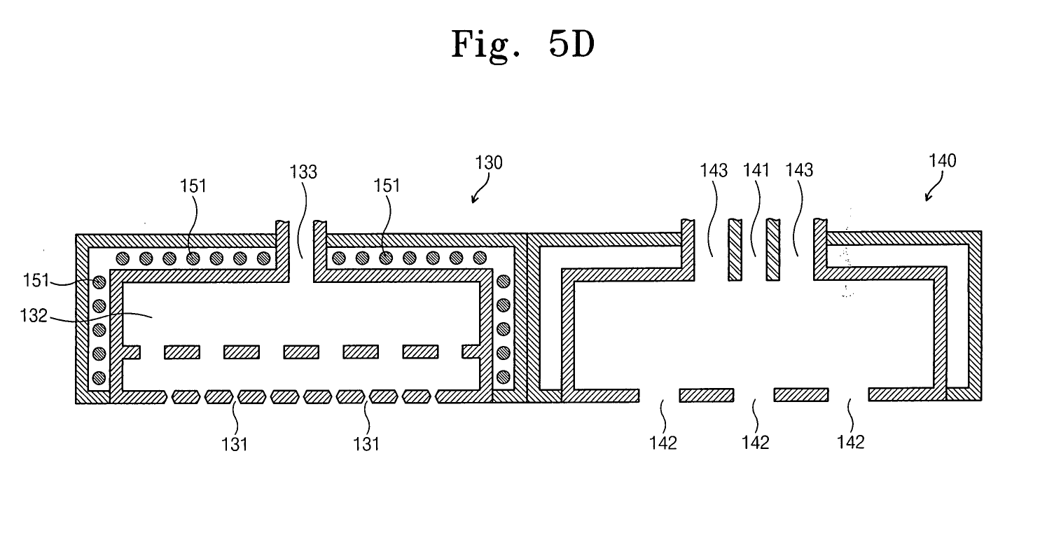

An adhesive injection device 130 for injecting an adhesive solution 135 to the filtering net 100 is disposed at the upper portion of the filtering net 100. The adhesive injection device 130 adheres the adhesive solution 135 to the filtering net 100 in the form of minute liquid drops. The adhesive solution drops 135 have a smaller size than an interval of the mesh patterns of the filtering net 100 and move toward the filtering net 100. As shown in FIG. 5A, in order to form the adhesive solution drops 135, the adhesive injection device 130 comprises injection nozzles 131. Furthermore, the adhesive injection device 130 comprises an adhesive solution storing unit 132 connected to the injection nozzles 131. The adhesive solution storing unit 132 is connected to an adhesive solution supply vessel through an adhesive solution supply line 133. Preferably, the injection nozzles 131 are divergent nozzles for injecting the adhesive solution 135 as minute liquid drops.

Referring back to FIG. 4A, a refining material supply device 140 is disposed between the adhesive injection device 130 and the filtering net transfer device 110, for supplying refining materials 145 to the surface of the filtering net 100. The supplied refining materials 145 are adhered to the filtering net 100 by the adhesive solution 135 coated on the filtering net 100. Preferably, the refining materials are selected from the group consisting of active carbons, impregnated active carbons, inorganic adsorbents and resins. Here, the types of refining materials are dependent upon the types of contaminants to be removed.

Now referring to FIG. 4B, another embodiment for the system for fabricating a filter structure is shown. Compared to the system in FIG. 4A, the system in FIG. 4B further comprises a first control device 151 and a second control device 152. The first control device 151 optimizes the injection properties of the adhesive solution 135, and the second control device 152 optimizes the adhesion properties of the adhesive solution 135. For example, the first control device 151 is disposed at the peripheral region of the adhesive injection device 130, for maintaining the adhesive solution 135 at a first temperature, and the second control device 152 controls the coated adhesive solution 135 at a second temperature. Here, the second temperature is generally lower than the first temperature.

Viscosity of liquid is inversely proportional to temperature; as viscosity is lowered, the injection properties of the liquid are improved. Therefore, the temperature of the adhesive solution 135 is preferably increased to improve the injection properties so long as the adhesion properties of the adhesive solution 135 are not deteriorated. In accordance with the invention, the adhesive solution 135 is controlled at a normal temperature to about 40° C. by the first control device 151. That is, preferably, the first temperature ranges from a normal temperature to about 40° C.

The coated adhesive solution 135 has optimum adhesion properties at a predetermined temperature (namely, a second temperature). The second control device 152 controls the temperature of the adhesive solution 135 to have the optimum adhesion properties. The adhesion properties of the adhesive solution 135 are influenced by the content, as well as the temperature, of the liquid. Accordingly, the second control device 152 may further include a drying device for drying the adhesive solution 135.

FIG. 5B is a cross-sectional diagram illustrating the adhesive injection device 130 having the first control device 151. Referring to FIG. 5B, the first control device 151 is disposed on, for example, the sides and top of the adhesive injection device 130. The first control device 151 is a heat transfer device for generating heat by using current, or a cooling pipe through which refrigerants, such as water, flow.

Preferably, the operation of the first control device 151 is electronically controlled by a predetermined controller (not shown). More preferably, a temperature sensor (not shown) for monitoring an inside temperature of the adhesive injection device 130 is electronically connected to the controller in order to control the operation of the first control device 151.

As shown in FIG. 5C, a first air injection line 134 is additionally connected to the adhesive injection device 130. The adhesive solution stored in the adhesive solution storing unit 132 may be more efficiently injected by the compressed air supplied through the first air injection line 134.

Yet another embodiment for the system for fabricating a filter structure is shown in FIG. 4C. The system in FIG. 4C incorporates the adhesive injection device 130 and the refining material supply device 140 in a single unit.

When injected, the adhesive solution 135 may be cooled. Therefore, the adhesive solution 135 may be provided with the optimum adhesion property directly after being coated on the filtering net 100. In this embodiment, as depicted in FIGS. 4C and 5D, the adhesive injection device 130 and the refining material supply device 140 may be incorporated in a single unit. That is, the system for fabricating the filter structure may supply the refining materials 145 directly after injecting the adhesive solution 135 to the filtering net 100 (without using the second control device 152 described in FIG. 4B).

Still referring to FIG. 5D, the refining material supply device 140 comprises a supply line 141 for supplying the refining materials 145, and discharge holes 142 for discharging the refining materials 145. The discharge holes 142 are formed toward the top surface of the filtering net 100. A second air injection line 143 for supplying a compressed air can be disposed on the circumference of the supply line 141. The refining materials 145 can be easily discharged to the top surface of the filtering net 100 by the second air injection line 143.

As shown in FIG. 4D, the adhesive injection device 130 may be rotated on a predetermined axis. Moreover, the refining material supply device 140 may also be rotated on a predetermined axis. The step for fabricating the filtering net by using the system comprises a first step for coating the adhesive solution 135 on the filtering net 100, and a second step for adhering the refining materials 145 to the filtering net 100. Preferably, in the first and second steps, the filtering net 100 moves in the reverse directions. In the first step, the rotated adhesive injection device 130 is operated, and in the second step, the rotated refining material supply device 140 is operated.

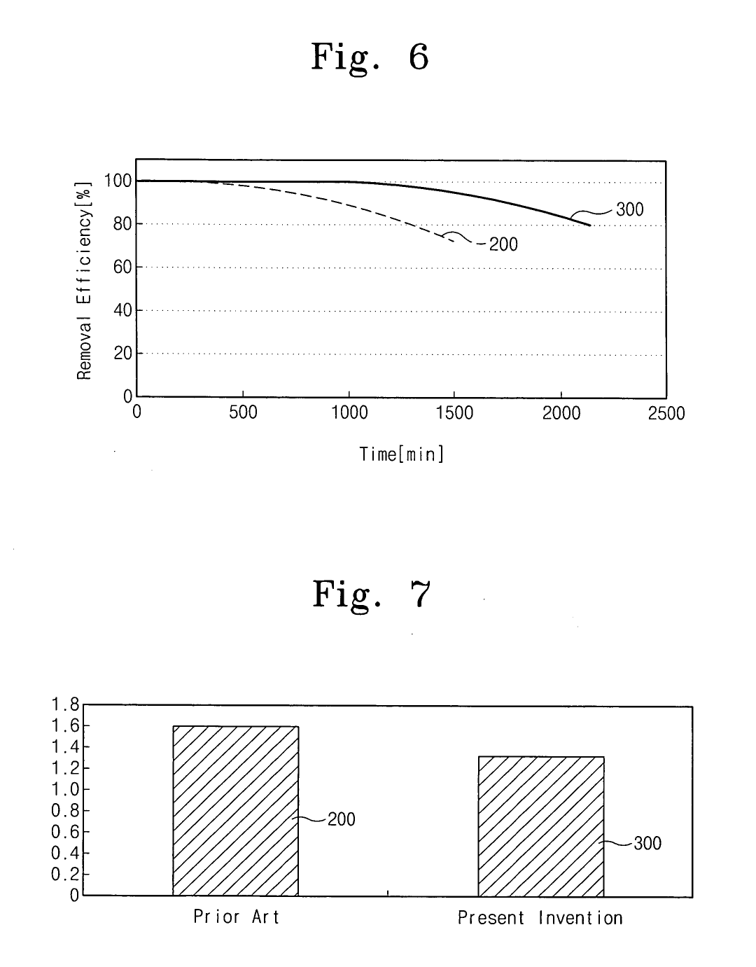

FIG. 6 is a graph showing filtering performance by time of the filtering nets manufactured by the conventional method and manufactured by the method of the invention. In the graph, a transverse axis shows time and an ordinates axis shows removal efficiency of contaminants. The contaminants used in the experiment are ozone, and the filtering nets are different in the methods for coating the adhesive. That is, the adhesive is coated according to the brushing process in the conventional art 200 and according to the injection process in the invention 300.

Referring to FIG. 6, when the filtering net 200 manufactured by the conventional method is used for about 1200 minutes, removal efficiency of the filtering net 200 is reduced to 80%. However, when the filtering net 300 manufactured by the method of the invention is used for about 2100 minutes, removal efficiency of the filtering net 300 reaches the same percentage (80%). As a result, longevity of the filtering net in accordance with the invention is improved by 75%.

FIG. 7 is a graph showing pressure loss in the filtering nets manufactured by the conventional method and the method of the invention. Also in this experiment, the adhesive is coated according to the brushing process in the conventional art 200 and the injection process in the invention 300. As shown in FIG. 7, pressure loss of the invention is about 80% of pressure loss of the conventional art. As explained above with reference to FIG. 3A, the adhesive 135 is injected and evenly coated on the filtering net, which minimizes the pressure loss of the filtering net. As the pressure loss decreases, the active rate of a fan used in a clean room may be reduced.

Moreover, as the adhesive 135 is evenly coated, the amount of unnecessarily-adhered refining materials may be reduced; thus, the whole weight of the filter structure may also be reduced. Since the refining materials are evenly adhered, the filter structure shows a low deterioration speed. That is, longevity of the filter structure may be extended.

Having described exemplary embodiments of the invention, it is noted that modifications and variations can be made by persons skilled in the art in light of the above teachings. Therefore, it is to be understood that changes may be made to embodiments of the invention disclosed that are nevertheless still within the scope and the spirit of the invention as defined by the appended claims.

What is claimed is:

1. A method for fabricating a filter structure, comprising:
preparing a filtering net having mesh patterns;
injecting an adhesive on the filtering net to produce a uniform adhesive coating; and
adhering refining materials to the filtering net coated with the adhesive.

2. The method as set forth in claim 1, injecting the adhesive comprises:
supplying the adhesive to an injection device having injection nozzles; and
injecting the supplied adhesive by applying a pressure to the injection device,
wherein the adhesive is maintained at a first temperature in the injection device.

3. The method as set forth in claim 2, further comprising changing the temperature of the adhesive coated on the filtering net into a second temperature before adhering the refining materials.

4. The method as set forth in claim 3, wherein the second temperature is lower than the first temperature.

5. The method as set forth in claim 2, wherein the adhesive is injected to have a smaller size than an interval of the mesh patterns of the filtering net.

6. The method as set forth in claim 1, wherein the adhesive is selected from the group consisting of urethane group adhesive, polyurethane group adhesive, aqueous vinylurethane group adhesive, epoxy group adhesive, acryl group adhesive, silicon group adhesive, synthetic resin group adhesive, and combinations thereof.

7. The method as set forth in claim 1, wherein the refining materials are selected from the group consisting of active carbons, impregnated active carbons, inorganic adsorbents, resins, and combinations thereof.

8. A system for fabricating a filter structure, comprising:
a filtering net disposed to cross a first position and a second position;
a filtering net transfer device connected to the filtering net in the second position, for transferring the filtering net from the first position to the second position; and
an adhesive injection device disposed between the first position and the second position, for injecting an adhesive solution on the filtering net.

9. The system as set forth in claim 8, wherein the filtering net comprises materials selected from the group consisting of metallic materials comprising aluminum, and polymers comprising polyethylene (PE), polypropylene (PP), polystyrene (PS), polyvinyl chloride (PVC), ethylene vinylacetate (EVA), polyethylene terephthalate (PET), polycarbonate (PC), polybutylene terephthalate (PBT), polyacetal (PA) and polyamide (PC).

10. The system as set forth in claim 8, wherein the filtering net has mesh patterns formed at predetermined intervals.

11. The system as set forth in claim 10, wherein the adhesive injection device transforms the adhesive solution into adhesive solution drops having a smaller size than the interval of the mesh patterns of the filtering net and transfers the adhesive solution drops toward the filtering net.

12. The system as set forth in claim 8, wherein the adhesive solution is selected from the group consisting of urethane group adhesive, polyurethane group adhesive, aqueous vinylurethane group adhesive, epoxy group adhesive, acryl group adhesive, silicon group adhesive and synthetic resin group adhesive.

13. The system as set forth in claim 8, wherein the adhesive injection device comprises an adhesive solution supply line having one end connected to an adhesive solution material vessel, an adhesive solution storing unit connected to the other end of the adhesive solution supply line, and one or more injection nozzles connected to the adhesive solution storing unit.

14. The system as set forth in claim 8, wherein the adhesive injection device further comprises a first control device for controlling the adhesive solution at a first temperature,
wherein the first control device is disposed at the peripheral regions of the adhesive solution supply line and the adhesive solution storing unit.

15. The system as set forth in claim 14, wherein the first control device is a heat transfer device.

16. The system as set forth in claim 13, wherein the injection nozzles are divergent nozzles for transforming the adhesive solution into minute liquid drops.

17. The system as set forth in claim 8, further comprising a refining material supply device disposed between the adhesive injection device and the filtering net transfer device, for supplying refining materials to the filtering net.

18. The system as set forth in claim 17, wherein the refining materials are selected from the group consisting of active carbons, impregnated active carbons, inorganic adsorbents, resins, and combinations thereof.

19. The system as set forth in claim 17, further comprising a second control device disposed between the refining material supply device and the adhesive injection device, for controlling the injected adhesive at a second temperature.

20. The system as set forth in claim 19, wherein the second control device is a cooling device.
